(19) United States
(12) Patent Application Publication
(10) Pub. No.: US 2011/0063260 A1
(43) Pub. Date: Mar. 17, 2011

(54) DRIVING CIRCUIT FOR LIQUID CRYSTAL DISPLAY

(75) Inventors: Kuang-Kuei WANG, Taoyuan City (TW); Chin-Hai HUANG, Pingzhen City (TW)

(73) Assignee: CHUNGHWA PICTURE TUBES, LTD., Bade City (TW)

(21) Appl. No.: 12/710,063

(22) Filed: Feb. 22, 2010

(30) Foreign Application Priority Data
Sep. 17, 2009 (TW) 098131427

(51) Int. Cl. G09G 5/00; G09G 3/36

(52) U.S. Cl. 345/204; 345/98

(57) ABSTRACT

The present invention provides driving circuit for a liquid crystal display with data line reducing abilities. A first sub scan signal line and a second sub scan signal line of a first main sub scan signal line disposed outside of an active area are connected to a first control transistor and a second control transistor. A gate of the first control transistor disposed outside of the active area is connected to a first sub scan signal line of next main scan signal line of the first main scan signal line. A gate of the second control transistor disposed outside of the active area is connected to a first sub scan signal line of next main scan signal line of the next main scan signal line.

### BACKGROUND

1. Field of the Invention

This invention relates to a liquid crystal display panel, and more particularly to a driving circuit for a liquid crystal display panel with data line reducing abilities.

2. Description of the Prior Art

The liquid crystal display device has the advantages including high-definition, small volume, light weight, low driving voltage, low power dissipation, radiation-free and more applications, and thereby to be as main technology of a display device. In general, the liquid crystal display device includes a liquid crystal display panel and a backlight module to provide a light source for the liquid crystal display panel.

In general, a liquid crystal display device includes two substrates, liquid crystals sealed there-between, pixel electrodes, thin film transistors configured on one substrate, color filter film corresponding to each of the pixel electrodes and common electrodes disposed on the other substrate. The color filter film consists of Red, Green and Blue three color filter films, and each of the pixels has one of the three color filter films formed thereon. Red, Green and Blue pixel are disposed adjacent together to form a picture element.

Moreover, it is desired that applied through the same data line to two adjacent pixels and applied through two scanning lines to drive pixels in a row to reach the purpose of reducing the number of data lines under being driven. Therefore, the number of scanning lines has increased by two times so that the number of scanning line driving integrated circuit will increase, and thereby raising the cost. Moreover, another improved scheme of reducing the number of data lines is also applied through a common data line to two adjacent pixels, and each pixel is driven by two transistors. It will considerably reduce aperture ratio. And, one pixel of the two adjacent pixels is driven by one thin-film transistor and another pixel of the two adjacent pixels is driven by two series thin-film transistors such that it will create a display issue due to non-uniform charging current between the two adjacent pixels. In such design, the parasitic capacitance in the pixel will be increased to lower quality of displaying.

Besides, when scanning pixels by conventional method, the unwanted pixel is turned on to create an incorrect transient pixel voltage which needs the following scanning signal to recover the correct pixel voltage. In view of the aforementioned drawbacks, the present invention provides an improved driving circuit for a liquid crystal display to reduce data lines and maintain the number of scanning lines, and thereby enhancing performance of the liquid crystal display.

### SUMMARY OF THE INVENTION

To overcome the prior art drawbacks, the present invention provides a driving circuit for a liquid crystal display panel, which utilizes a scanning line selected circuit disposed outside of an active (display) area. A specific scanning method is provided to reach the purpose of identical scanning lines and resolution which is without changing pixels layout in the active area.

Another objective of the present invention is to provide a liquid crystal display panel with data line reduction.

Yet another objective of the present invention is to provide a liquid crystal display panel without increasing number of scanning driving integrated circuit to reach the purpose of lower cost. To obtain the purpose of above-mentioned, the present invention provides a driving circuit for a liquid crystal display panel, which comprises plurality of main scanning lines disposed outside of an active area, wherein each of the plurality of main scanning lines include a first sub-scanning line a second sub-scanning line; a plurality of control transistors disposed outside of the active area, wherein the first sub-scanning line and the second sub-scanning line of a first main scanning line are coupled to a first control transistor and a second control transistor of the plurality of control transistors, respectively; and wherein gate of the first control transistor is coupled to the first sub-scanning line of next main scanning line of the first main scanning line, and gate of the second control transistor is coupled to the first sub-scanning line of next two main scanning line of the first main scanning line.

The another aspect of the present invention is a method for scanning of a liquid crystal display panel which comprises applying a first voltage to a first main scanning line and a second voltage to a second main scanning line such that signal of the first main scanning line is passing through a first sub-scanning line and a second sub-scanning line and entering source of a first control transistor and source of a second control transistor; turning on the first control transistor and transmitting the signal to a first pixel by a first switch transistor; subsequently applying a third voltage to the first main scanning line and a fourth voltage to a third main scanning line such that signal of the first main scanning line is passing through the first sub-scanning line and the second sub-scanning line and entering source of the first control transistor and source of the second control transistor; successively turning on the second control transistor and transmitting the signal to a second pixel by a second switch transistor; wherein the first main scanning line includes a first sub-scanning line a second sub-scanning line, the second main scanning line includes a third sub-scanning line a fourth sub-scanning line, the third main scanning line includes a fifth sub-scanning line a sixth sub-scanning line; wherein the first sub-scanning line and the second sub-scanning line are coupled to the first control transistor and the second control transistor, respectively; and wherein gate of the first control transistor is coupled to the fifth sub-scanning line, and gate of the second control transistor is coupled to the sixth sub-scanning line.

Furthermore, the first, second, third main scanning lines, and the first, second, third, fourth, fifth and sixth sub-scanning lines, and the first and second control transistors are all disposed outside of an active area.

### BRIEF DESCRIPTION OF THE DRAWINGS

The above objects, and other features and advantages of the present invention will become more apparent after reading the following detailed description when taken in conjunction with the drawings, in which:

FIG. 1 is a circuit diagram of a liquid crystal display panel according to the present invention.

FIG. 2 is a circuit diagram of a liquid crystal display panel according to the present invention.

FIG. 3 is a circuit diagram of a liquid crystal display panel according to the present invention.

FIG. 4 is a circuit diagram of a liquid crystal display panel according to the present invention.

FIG. 5 is a circuit diagram of a liquid crystal display panel according to the present invention.

FIG. 6 is a circuit diagram of a liquid crystal display panel according to the present invention.

FIG. 7 is a circuit diagram of a liquid crystal display panel according to the present invention.

FIG. 8 is a circuit diagram of a liquid crystal display panel according to the present invention.

FIG. 9 is a circuit diagram of a liquid crystal display panel according to the present invention.

FIG. 10 is a circuit diagram of a liquid crystal display panel according to the present invention.

FIG. 11 is time chart of scanning of a liquid crystal display panel according to the present invention.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

To overcome the prior art drawbacks, the present invention provides a driving circuit for a liquid crystal display panel which utilizes a scanning line selecting circuit disposed outside of an active area. It needs not to change pixels configuration in the active area, and utilizing a specific scanning method to reach the purpose of the identical scanning lines and resolution.

The present invention provides a thin-film transistor liquid crystal display which peripheral circuit is driven by data line reduction. Moreover, it needs not to increase the number of scanning line driving integrated circuit to lower cost.

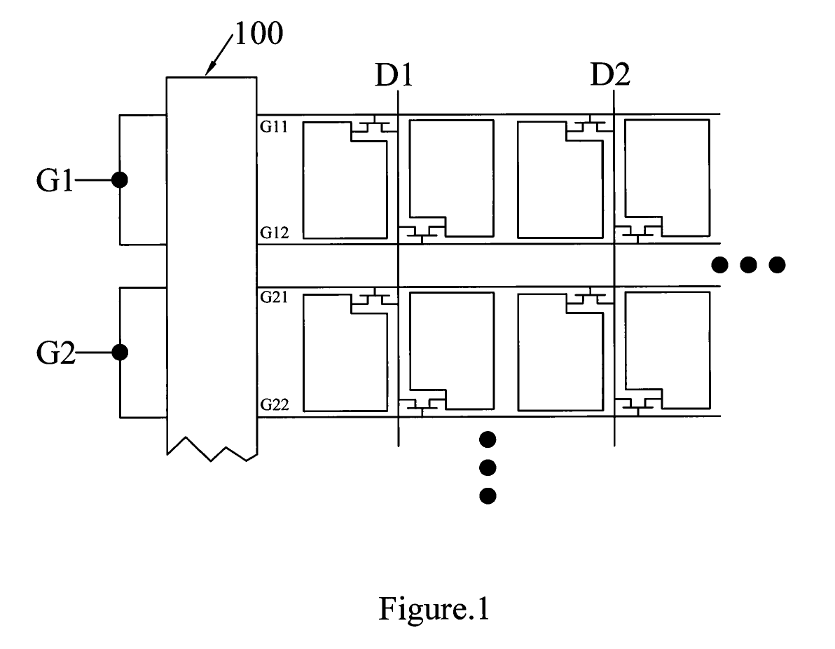

FIG. 1 shows a circuit diagram of a liquid crystal display panel of the present invention. In some embodiments of the invention, the identical components will not be described or explained repeatedly. Moreover, the embodiment of the present invention is expressly not limited to driving circuit for a liquid crystal display panel made by the present invention. A driving circuit 100 is disposed outside of an active area. In FIG. 1, a plurality of scanning lines G1, G2 are disposed in row direction, and a plurality of data lines D1, D2 are disposed in column direction intersecting with the scanning lines. In the intersecting point of the scanning lines and the data lines, a first switch and a second switch may be disposed on bilateral pixel area of the data line respectively. A first pixel electrode and a second pixel electrode are connected to the first switch and the second switch respective. A video signal is transmitted to the first pixel electrode and the second pixel electrode by on/off operation of the first switch and the second switch, respectively.

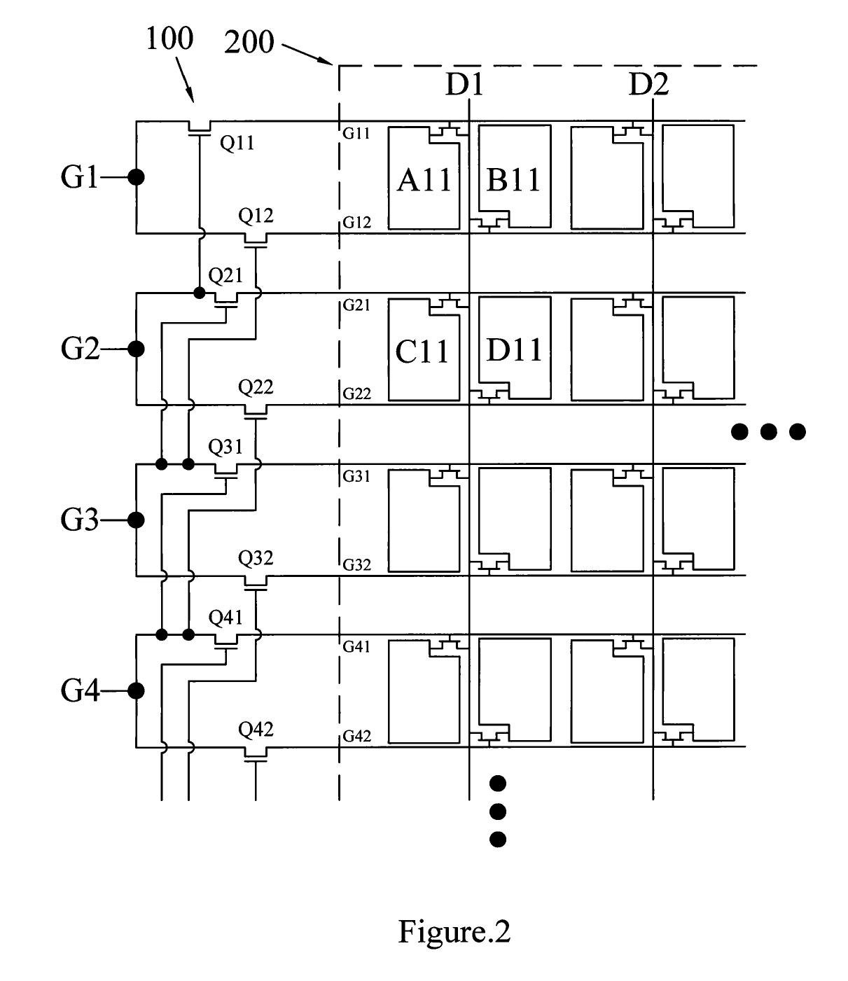

FIG. 2 shows a circuit diagram of a liquid crystal display panel of the present invention. In FIG. 2, it illustrates a driving circuit 100 disposed outside of an active (display) area, and pixels in the active area 200 are designed with data line reduction. The scheme of the present invention is applied through a common data line for two adjacent pixels, wherein one thin-film transistor is applied to one pixel. Each individual thin-film transistor disposed in two adjacent pixels is connected to two sub-scanning line of a main scanning line, wherein upper sub-scanning line is connected to a thin-film transistor in a first pixel and lower sub-scanning line is connected to a thin-film transistor in a second pixel. Driving signal applied to the main scanning line is controlled for allowing a video signal transmitting to the adjacent pixels (for example right and left pixels) by a data line, and thereby reducing half number of data lines.

In scanning selected circuit scheme of the present invention, a single main scanning line is divided into two sub-scanning lines which are coupled to a corresponding thin-film transistor, respectively. Gate of the corresponding thin-film transistor is coupled to the next or the next two sub-scanning line respectively to reach the purpose of data line reduction. Pixels A11, B11, C11 and D11 on the upper left corner of FIG. 2 are illustrated as explaining scanning method of the present invention.

In FIG. 2, it shows selected circuits (driving circuit) 100 on left part and display area pixels 200 on right part. For example a main scanning line G1, the main scanning line G1 outputted by a scanning integrated circuit is divided into two sub-scanning lines G11, G12 prior to the display area pixels 200. The sub-scanning lines G11, G12 are connected to thin-film transistors Q11, Q12, respectively. Similarly, a main scanning line G2 is divided into two sub-scanning lines G21, G22 prior to the display area pixels 200. The sub-scanning lines G21, G22 are connected to thin-film transistors Q21, Q22, respectively. A main scanning line G3 is divided into two sub-scanning lines G31, G32 prior to the display area pixels 200. The sub-scanning lines G31, G32 are connected to thin-film transistors Q31, Q32, respectively. As above-mention disposition, a main scanning line G4 is divided into two sub-scanning lines G41, G42 prior to the display area pixels 200. The sub-scanning lines G41, G42 are connected to thin-film transistors Q41, Q42, respectively. Further, in a main scanning line (for example N-th main scanning line, N is natural number), gate of a first thin-film transistor switch is coupled to a first sub-scanning line of next main scanning line ((N+1) main scanning line), and gate of a second thin-film transistor switch is coupled to a first sub-scanning line of next two main scanning line (N+2 scanning line). Therefore, gate of the first thin-film transistor switch Q11 of N-th main scanning line is coupled to the sub-scanning line G21 of (N+1)-th main scanning line, and gate of the second thin-film transistor switch Q12 of N-th main scanning line is coupled to the sub-scanning line G31 of (N+2)-th main scanning line. Gate of the first thin-film transistor switch Q21 of (N+1)-th main scanning line is coupled to the sub-scanning line G31 of (N+2)-th main scanning line, and gate of the second thin-film transistor switch Q22 is coupled to the sub-scanning line G41 of (N+3)-th main scanning line. Gate of the first thin-film transistor switch Q31 of (N+2)-th main scanning line is coupled to the sub-scanning line G41 of (N+3)-th main scanning line, and gate of the second thin-film transistor switch Q32 is coupled to the sub-scanning line G51 (not shown) of (N+4)-th main scanning line. Similarly, gate of the first thin-film transistor switch Q41 of (N+3)-th main scanning line is coupled to a sub-scanning line G51 (not shown) of (N+4)-th main scanning line, and gate of the second thin-film transistor switch Q42 is coupled to a sub-scanning line G61 (not shown) of (N+5)-th main scanning line.

According to scheme of the present invention, for example the main scanning line G1 (N-th main scanning line), when the main scanning lines G1 and G2 ((N+1)-th main scanning line) are scanned, scanning line G1 signal outputted by a scanning integrated circuit entering source of the thin-film transistor switch Q11, Q12. Therefore, gate of the thin-film transistor switch Q11 is turned on when the main scanning line G1 (N-th main scanning line) and the main scanning line G2 ((N+1)-th main scanning line) perform a scanning simultaneously. Gate of the thin-film transistor switch Q12 is turned on when the main scanning line G1 and the main scanning line G3 ((N+2)-th main scanning line) perform a scanning simultaneously.

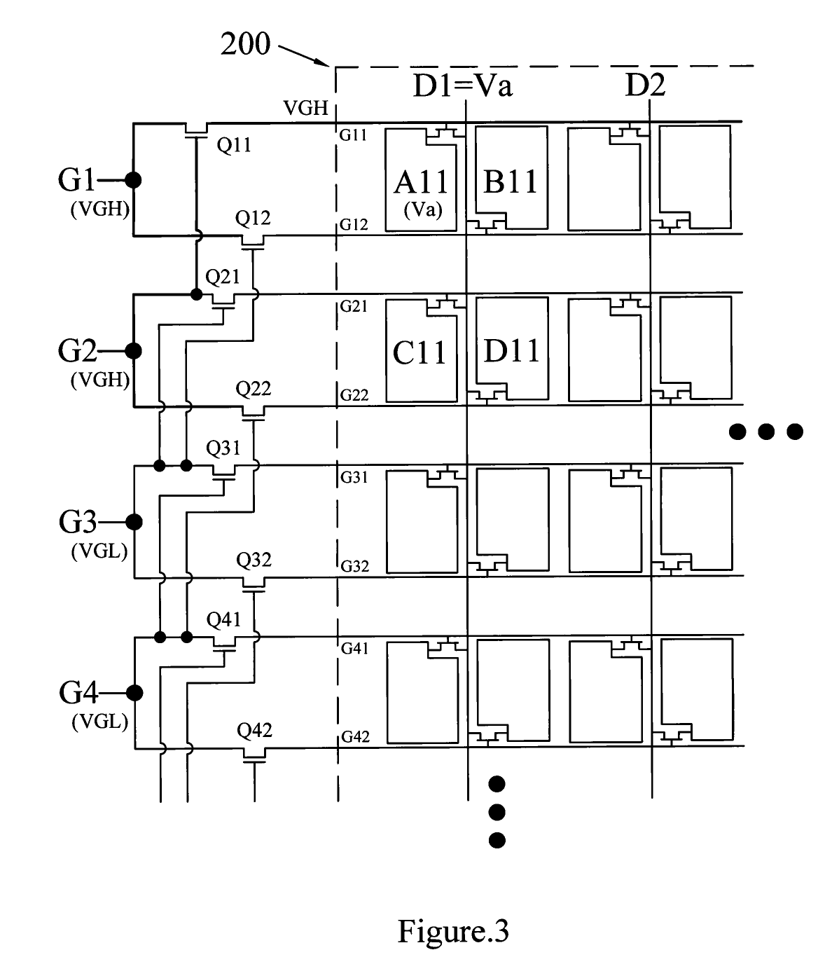

Scanning method, driving method and operation of gate of the thin-film transistor switch are referred to FIG. 3 to FIG. 10.

As seen in FIG. 3, when the main scanning line G1 (N-th main scanning line) and the main scanning line G2 ((N+1)-th main scanning line) are turned on by applied a high voltage VGH respectively, N-th main scanning line G1 signal is passing through the sub-scanning line G11, G12 and then entering source of the thin-film transistor switch Q11, Q12, and the sub-scanning line G21 of (N+1)-th main scanning line G2 is coupled to gate of the thin-film transistor switch Q11 and thereby turning on the thin-film transistor switch Q11. The scanning signal is transmitted to the pixel All by a transistor. Voltage of the sub-scanning line G11 entering the display area pixel 200 is a high voltage, and voltage of data line D1 is Va and voltage of the All pixel is Va.

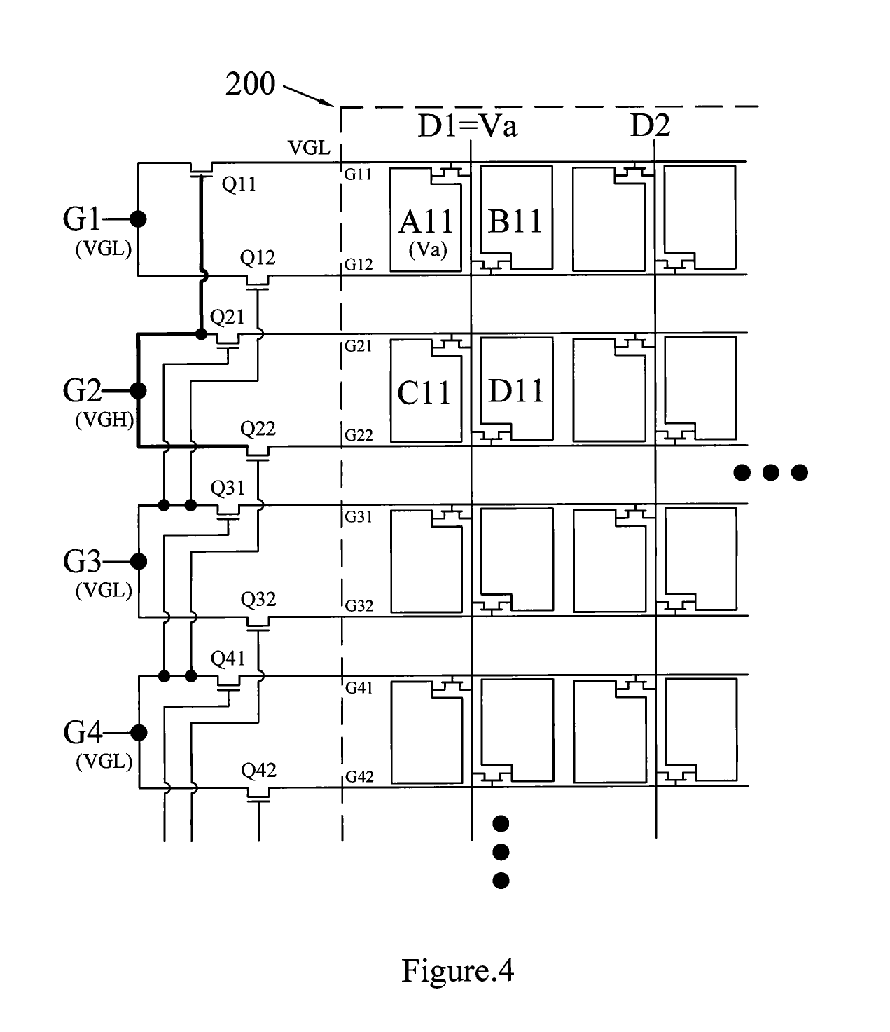

Similarly, as seen in FIG. 4, N-th main scanning line G1 is applied to a low voltage VGL to turn off and (N+1)-th main scanning line G2 is applied to a high voltage VGH to turn on. The sub-scanning line G21 of the (N+1)-th main scanning line G2 is coupled to gate of the thin-film transistor switch Q11 and thereby turning on the thin-film transistor switch Q11. The scanning signal is transmitted to the pixel A11 by a transistor. Voltage of the sub-scanning line G11 entering the display area pixel 200 is a low voltage, and voltage of data line D1 is Va and voltage of the All pixel is Va.

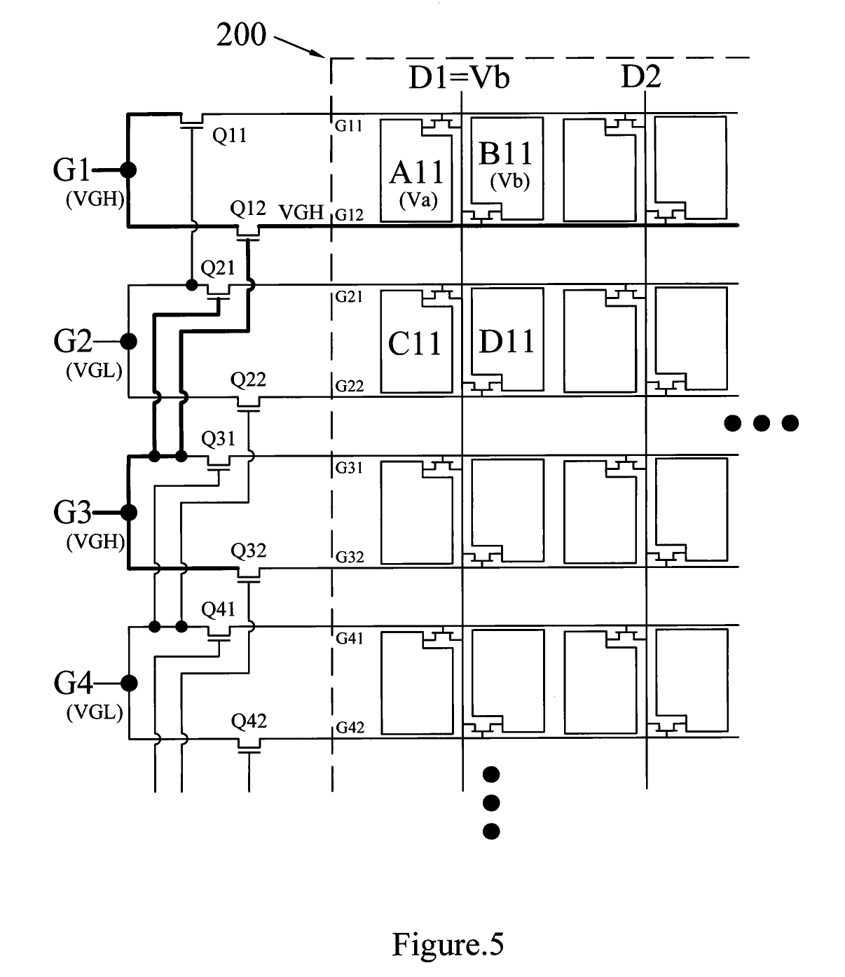

Subsequently, as seen in FIG. 5, when N-th main scanning line G1 and (N+2)-th main scanning line G3 are turned on by applied a high voltage VGH respectively, N-th main scanning line G1 signal is passing through the sub-scanning line G11, G12 and then entering source of the thin-film transistor switch Q11, Q12, and the sub-scanning line G31 of (N+2)-th main scanning line G3 is coupled to gate of the thin-film transistor switch Q12, Q21 and thereby turning on the thin-film transistor switch Q12. The scanning signal is transmitted to the pixel B11 by a transistor. Voltage of the sub-scanning line G12 entering the display area pixel 200 is a high voltage, and voltage of data line D1 is Vb and voltage of the B11 pixel is Vb.

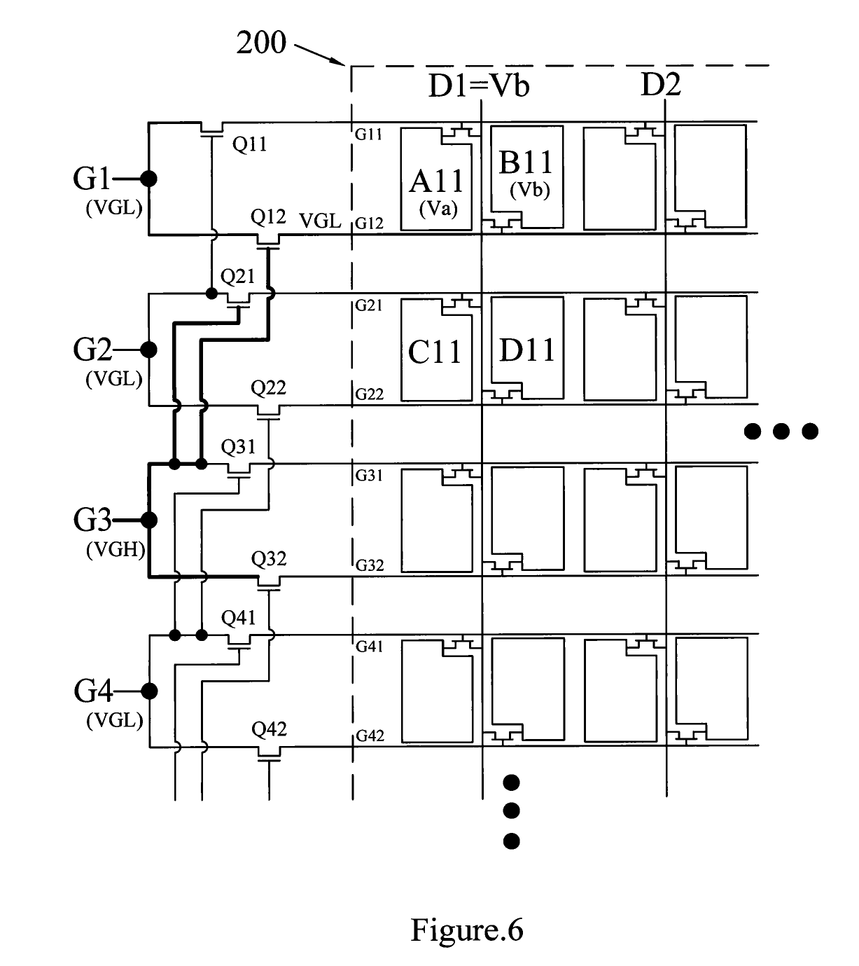

Similarly, as seen in FIG. 6, N-th main scanning line G1 is applied to a low voltage VGL to turn off and (N+2)-th main scanning line G3 is applied to a high voltage VGH to turn on. The sub-scanning line G31 of the (N+2)-th main scanning line G3 is coupled to gate of the thin-film transistor switch Q12, Q21 and thereby turning on the thin-film transistor switch Q12. The scanning signal is transmitted to the pixel B11 by a transistor. Voltage of the sub-scanning line G12 entering the display area pixel 200 is a low voltage, and voltage of data line D1 is Vb and voltage of the B11 pixel is Vb.

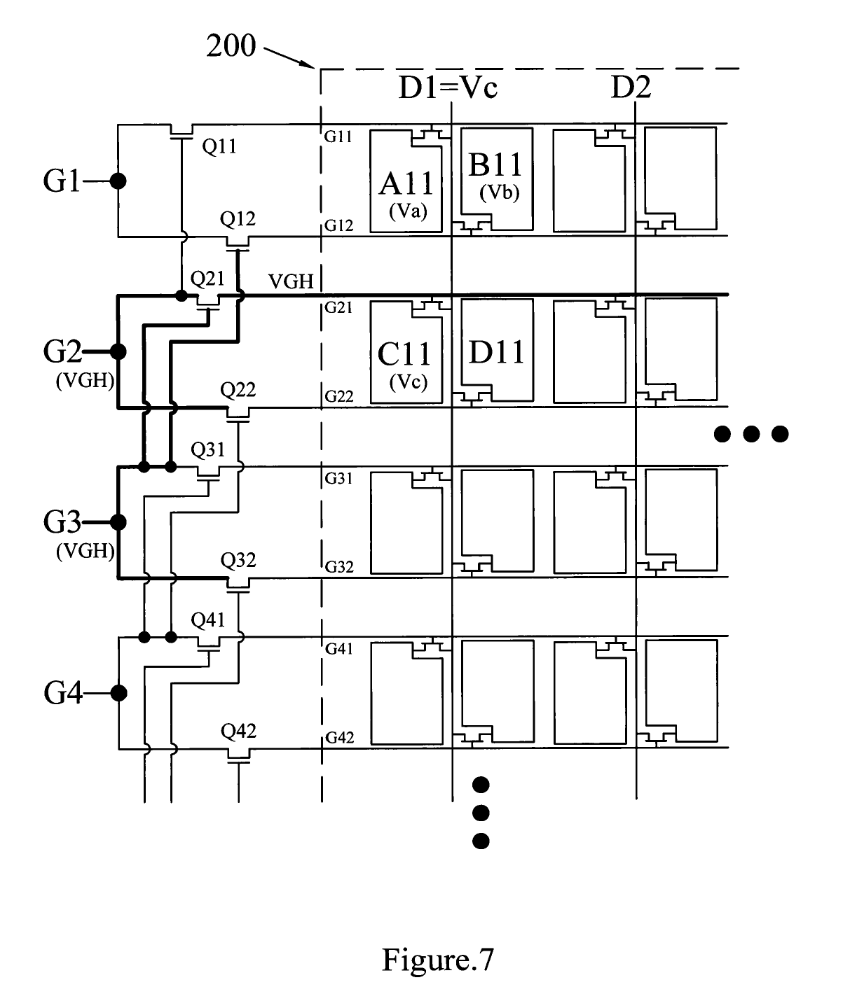

As seen in FIG. 7, when (N+1)-th main scanning line G2 and (N+2)-th main scanning line G3 are also turned on by applied a high voltage VGH respectively, (N+1)-th main scanning line G2 signal is passing through the sub-scanning line G21, G22 and then entering source of the thin-film transistor switch Q21, Q22, and the sub-scanning line G31 of (N+2)-th main scanning line G3 is coupled to gate of the thin-film transistor switch Q12, Q21 and thereby turning on the thin-film transistor switch Q21. The scanning signal is transmitted to the pixel C11 by a transistor. Voltage of the sub-scanning line G21 entering the display area pixel 200 is a high voltage, and voltage of data line D1 is Vc and voltage of the C11 pixel is Vc.

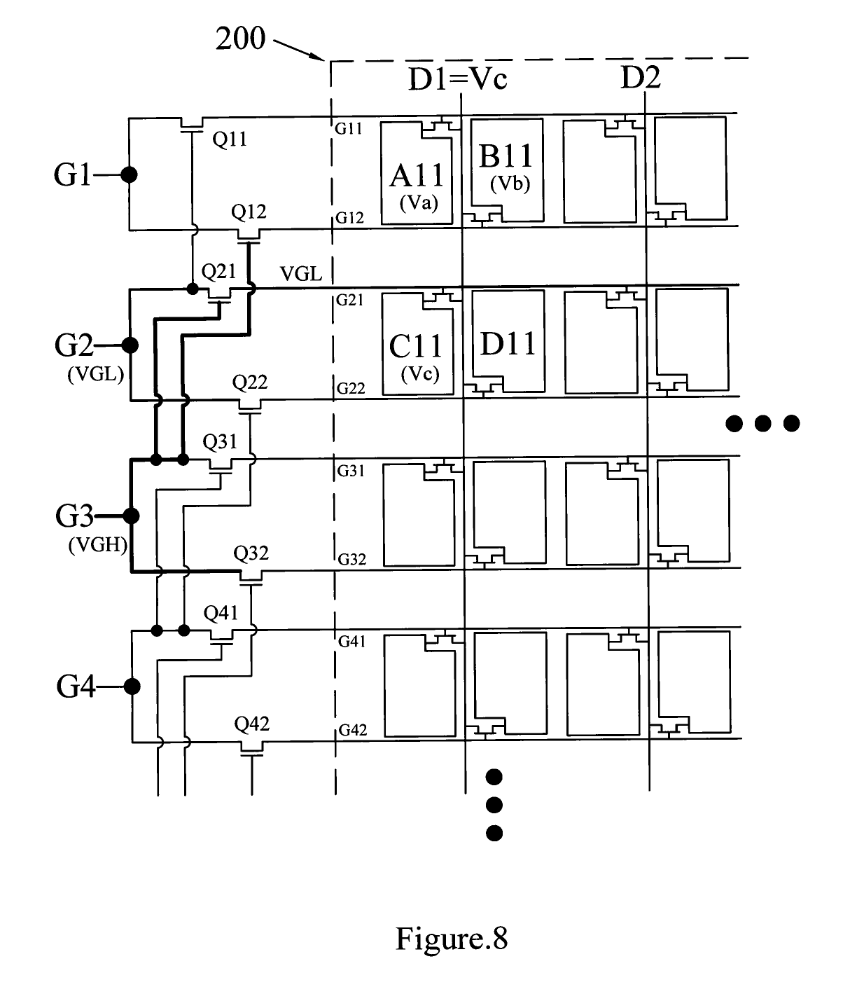

Similarly, as seen in FIG. 8, (N+1)-th main scanning line G2 is applied to a low voltage VGL to turn off and (N+2)-th main scanning line G3 is applied to a high voltage VGH to turn on. The sub-scanning line G31 of the (N+2)-th main scanning line G3 is coupled to gate of the thin-film transistor switch Q12, Q21 and thereby turning on the thin-film transistor switch Q21. The scanning signal is transmitted to the pixel C11 by a transistor. Voltage of the sub-scanning line G21 entering the display area pixel 200 is a low voltage, and voltage of data line D1 is Vc and voltage of the C11 pixel is Vc.

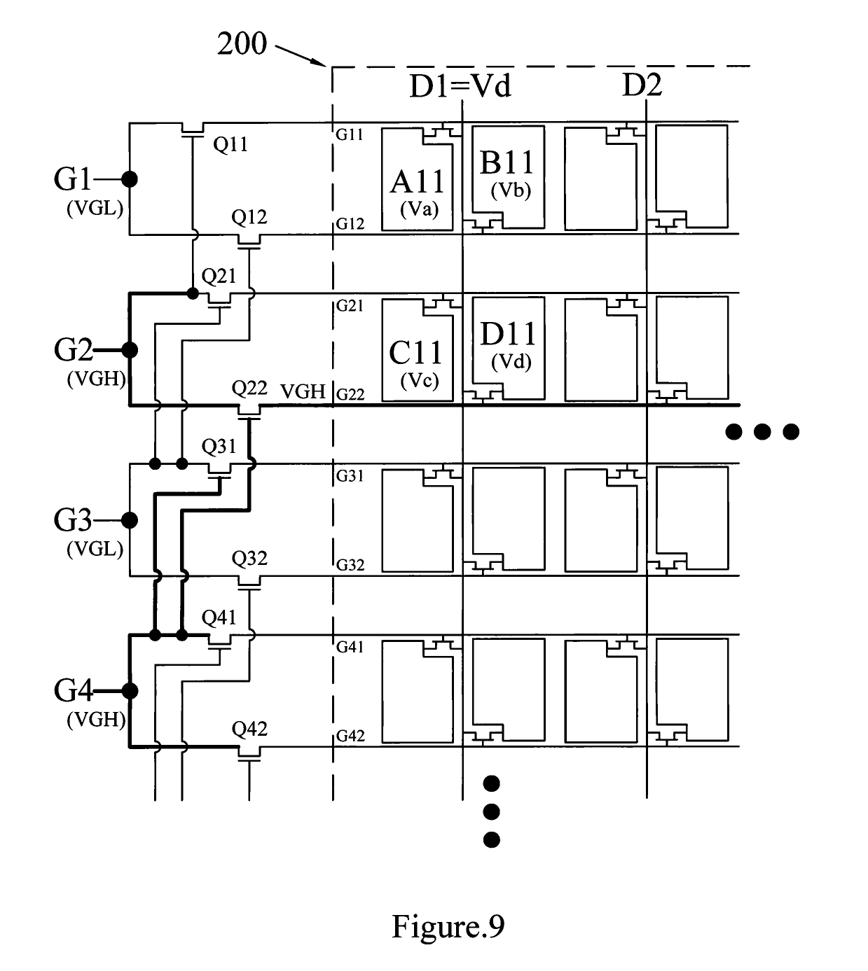

As seen in FIG. 9, when (N+1)-th main scanning line G2 and (N+3)-th main scanning line G4 are also turned on by applied a high voltage VGH respectively, (N+1)-th main scanning line G2 signal is passing through the sub-scanning line G21, G22 and then entering source of the thin-film transistor switch Q21, Q22, and the sub-scanning line G41 of (N+3)-th main scanning line G4 is coupled to gate of the thin-film transistor switch Q31, Q22 and thereby turning on the thin-film transistor switch Q22. The scanning signal is transmitted to the pixel D11 by a transistor. Voltage of the sub-scanning line G22 entering the display area pixel 200 is a high voltage, and voltage of data line D1 is Vd and voltage of the D11 pixel is Vd.

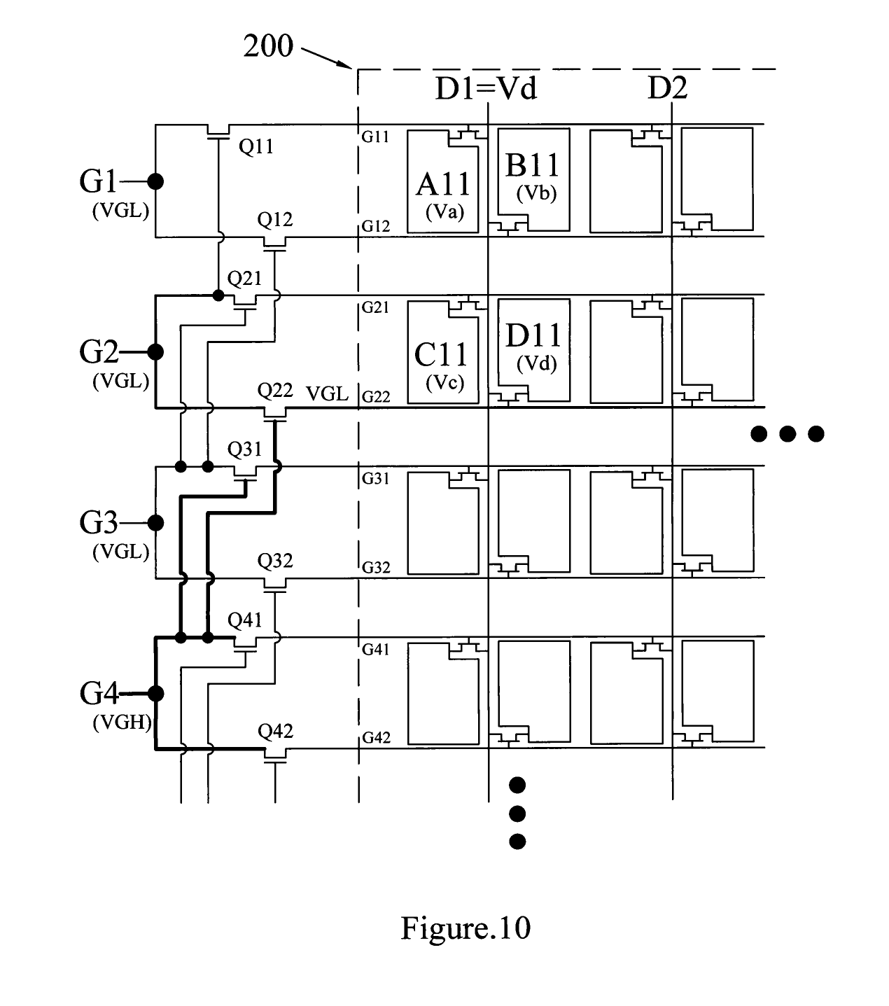

Similarly, as seen in FIG. 10, (N+1)-th main scanning line G2 is applied to a low voltage VGL to turn off and (N+3)-th main scanning line G4 is applied to a high voltage VGH to turn on. The sub-scanning line G41 of the (N+3)-th main scanning line G4 is coupled to gate of the thin-film transistor switch Q31, Q22 and thereby turning on the thin-film transistor switch Q22. The scanning signal is transmitted to the pixel D11 by a transistor. Voltage of the sub-scanning line G22 entering the display area pixel 200 is a low voltage, and voltage of data line D1 is Vd and voltage of the D11 pixel is Vd.

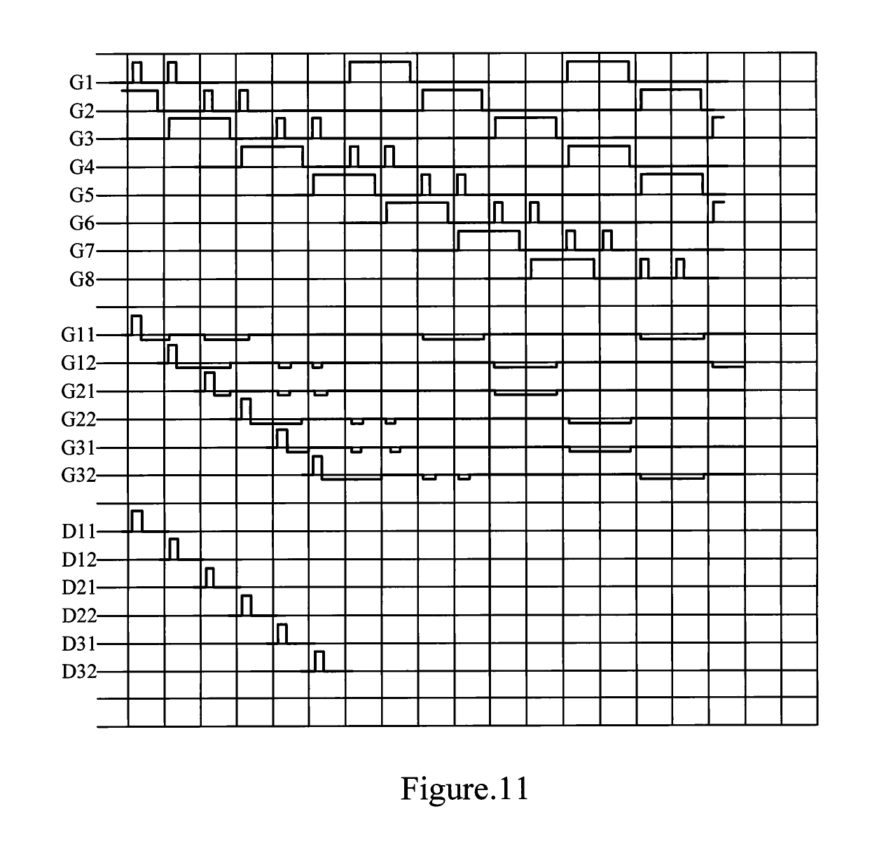

On/off state of pixel of the present invention is controlled by an additional transistor, and two adjacent pixels is coupled to a common data line. Scanning method of the present invention is followed by the above-mentioned scanning steps. As described above driving method and FIG. 3 to FIG. 10, the turned on sub-scanning line by a high voltage VGH can drive a transistor of a pixel to input (write) data, and then sub-scanning line may be applied to a low voltage VGL for turning off the transistor to recover voltage state of the pixel. Moreover, gate of thin-film transistor of the selected circuit is not turned on by a high voltage VGH (it means that scanning period signal is not input into its sub-scanning line yet) such that its gate terminal is in floating voltage state. In normal scanning situation, regular or periodic high voltage is sent to turn on thin-film transistor of the selected circuit such that un-scanned sub-scanning line can keep a low state voltage to further promote stability of the liquid crystal device panel. In one embodiment, time charts of the main scanning line, the sub-scanning line and the data line of the present invention are shown in FIG. 11.

Therefore, it can not be found that transient voltage of non-required pixel is incorrect because such pixel will not to be turned on in scanning process. To sum up, advantages of the present invention are as follows:

(1) Aperture ratio will not be reduced and signal coupling issue caused by cross-lines will not be happened on the active area, because the driving circuit is disposed on the peripheral region of the active area;

(2) A transistor is selected to dispose on the scanning line to act as a switch, utilizing Gn and Gn+1 (or Gn+2) scanning line coupled to data line for turning on the transistor to reach the purpose of imaging, higher operation speed and lower cost;

(3) A selected switch is disposed outside of the active (display) area such that flexibility of design and spatial layout can be greatly increased;

(4) Enabling line and corresponding judgment circuit are omitted;

(5) Number of the scanning lines is identical and half number of the data lines is required to reach the same resolution, and it is without increasing the number of transistors on the display area;

(6) The present invention provides a better performance of display due to less metal cross-line and lower parasitic capacitance in the pixel;

(7) The present invention can reduce occupied area of the transistors, and it can enhance performance of display due to scanning lines and data lines reduction to lower parasitic capacitance in the pixel;

(8) Two adjacent pixels coupled to a common data line are charged by the same condition thin-film transistor so that performance of display is more uniform.

The above description of the invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A driving circuit for a liquid crystal display panel, comprising:
a plurality of main scanning lines disposed outside of an active area, wherein each of said plurality of main scanning lines include a first sub-scanning line a second sub-scanning line;
a plurality of control transistors disposed outside of said active area, wherein said first sub-scanning line and said second sub-scanning line of a first main scanning line are coupled to a first control transistor and a second control transistor of said plurality of control transistors, respectively; and
wherein gate of said first control transistor is coupled to said first sub-scanning line of next main scanning line of said first main scanning line, and gate of said second control transistor is coupled to said first sub-scanning line of next two main scanning line of said first main scanning line.

2. The driving circuit for a liquid crystal display panel of claim 1, wherein said control transistor is thin film transistor.

3. The driving circuit for a liquid crystal display panel of claim 1, wherein said first sub-scanning line and said second sub-scanning line are coupled to a plurality of data lines.

4. The driving circuit for a liquid crystal display panel of claim 1, wherein a first switch transistor and a second switch transistor of two adjacent pixels are coupled to said first sub-scanning line and said second sub-scanning line, respectively.

5. The driving circuit for a liquid crystal display panel of claim 4, wherein said first switch transistor and said second switch transistor are thin film transistor.

6. The driving circuit for a liquid crystal display panel of claim 4, wherein said two adjacent pixels are coupled a common data line.

7. The driving circuit for a liquid crystal display panel of claim 6, wherein source of said first switch transistor and said second switch transistor of said two adjacent pixels are coupled to said common data line.

8. A method for scanning of a liquid crystal display panel, comprising:
applying a first voltage to a first main scanning line and a second voltage to a second main scanning line such that signal of said first main scanning line is passing through a first sub-scanning line and a second sub-scanning line and entering source of a first control transistor and source of a second control transistor;
turning on said first control transistor and transmitting said signal to a first pixel by a first switch transistor;
applying a third voltage to said first main scanning line and a fourth voltage to a third main scanning line such that signal of said first main scanning line is passing through said first sub-scanning line and said second sub-scanning line and entering source of said first control transistor and source of said second control transistor;
turning on said second control transistor and transmitting said signal to a second pixel by a second switch transistor;
wherein said first main scanning line includes a first sub-scanning line a second sub-scanning line, said second main scanning line includes a third sub-scanning line a fourth sub-scanning line, said third main scanning line includes a fifth sub-scanning line a sixth sub-scanning line;
wherein said first sub-scanning line and said second sub-scanning line are coupled to said first control transistor and said second control transistor, respectively; and
wherein gate of said first control transistor is coupled to said fifth sub-scanning line, and gate of said second control transistor is coupled to said sixth sub-scanning line.

9. The method for scanning of a liquid crystal display panel of claim 8, wherein said first and said second control transistor is thin film transistor.

10. The method for scanning of a liquid crystal display panel of claim 8, wherein said first, said second, said third, said fourth, said fifth and said sixth sub-scanning lines are coupled to a plurality of data lines.

11. The method for scanning of a liquid crystal display panel of claim 8, wherein said first switch transistor of said first pixel and said second switch transistor of said second pixel are coupled to said first sub-scanning line and said second sub-scanning line, respectively.

12. The method for scanning of a liquid crystal display panel of claim 8, wherein said first switch transistor and said second switch transistor are thin film transistor.

13. The method for scanning of a liquid crystal display panel of claim 8, wherein said first and said second pixels are coupled a common data line.

14. The method for scanning of a liquid crystal display panel of claim 13, wherein source of said first switch transistor and said second switch transistor of said first and said second pixels are coupled to said common data line.

15. The method for scanning of a liquid crystal display panel of claim 8, wherein said first, said second, said third main scanning lines, said first, said second, said third, said fourth, said fifth and said sixth sub-scanning lines, and said first and said second control transistors are disposed outside of an active area.
